(19) United States
(12) Patent Application Publication
(10) Pub. No.: US 2025/0272084 A1
(43) Pub. Date: Aug. 28, 2025

(54) FILE DEEP COMPARE TOOL REALIZATION

(71) Applicant: Dell Products, L.P, Round Rock, TX (US)

(72) Inventor: Hui Cao, Shanghia (CN)

(73) Assignee: Dell Products, L.P, Round Rock, TX (US)

(21) Appl. No.: 18/741,995

(22) Filed: Jun. 13, 2024

(30) Foreign Application Priority Data
Feb. 28, 2024 (CN) 202410223579.1

(51) Int. Cl. G06F 8/658; G06F 16/17

(52) U.S. Cl. CPC G06F 8/658; G06F 16/1734

(57) ABSTRACT

Methods, system, and non-transitory processor-readable storage medium for a file deep compare system are provided herein. An example method includes a patch installation package generator system that receives a plurality of files and a request to generate a patch installation package incorporating a subset of changed files for installation, where the plurality of files comprises the subset of changed files and a subset of unchanged files. A deep file compare system generates human readable files from binary files, wherein the plurality of files comprises the binary files. The deep file compare system determines the subset of changed files within the plurality of files, using the human readable files, and outputs the subset of changed files for generation of the patch installation package incorporating the subset of changed files.

### FIELD

The field relates generally to generating patch installation packages in information processing systems, and more particularly to determining which changed files the patch installation package requires.

### BACKGROUND

Generating patch installation packages provide customers with resolutions to their issues. Customers install the patch package to fix existing issues and security vulnerabilities. The patch installation packages contain files that are necessary to be installed on the customers' systems to provide the resolutions to their issues.

### SUMMARY

Illustrative embodiments provide techniques for implementing a file deep compare system in a storage system. For example, illustrative embodiments provide a patch installation package generator system that receives a plurality of files and a request to generate a patch installation package incorporating a subset of changed files for installation, where the plurality of files comprises the subset of changed files and a subset of unchanged files. A deep file compare system generates human readable files from binary files, where the plurality of files comprises the binary files. The deep file compare system determines the subset of changed files within the plurality of files, using the human readable files, and outputs the subset of changed files for generation of the patch installation package incorporating the subset of changed files. Other types of processing devices can be used in other embodiments. These and other illustrative embodiments include, without limitation, apparatus, systems, methods and processor-readable storage media.

### BRIEF DESCRIPTION OF THE DRAWINGS

FIG. 1 shows an information processing system including a file deep compare system in an illustrative embodiment.

FIG. 2 shows a flow diagram of a process for a file deep compare system in an illustrative embodiment.

FIG. 3 shows a file deep compare system in an illustrative embodiment.

FIG. 4 shows a schema state machine associated with a file deep compare system in an illustrative embodiment.

FIG. 5 shows a deep compare workflow associated with a file deep compare system in an illustrative embodiment.

FIGS. 6 and 7 show examples of processing platforms that may be utilized to implement at least a portion of a file deep compare system embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

Described below is a technique for use in implementing a file deep compare system, which technique may be used to provide, among other things a new optimized deep compare system that precisely identifies changed files, particularly for binary files. A patch installation package generator system receives a plurality of files and a request to generate a patch installation package incorporating a subset of changed files for installation, where the plurality of files comprises the subset of changed files and a subset of unchanged files. A deep file compare system generates human readable files from binary files, where the plurality of files comprises the binary files. The deep file compare system determines the subset of changed files within the plurality of files, using the human readable files, and outputs the subset of changed files for generation of the patch installation package incorporating the subset of changed files. Other types of processing devices can be used in other embodiments.

Generation of patch installation packages requires amassing the changed files necessary to resolve customer issues, as well as any necessary auxiliary files. A patch installation package with too many unnecessary files (i.e., files that are unchanged and not needed to resolve customer issues) can be extremely large and can result in the failure of the installation of the patch installation package.

Conventional technologies for generating patch installation packages do not provide a way to identify changed files with compiled binary files, which are not directly readable. Conventional technologies do not identify only the changed files and, instead, include unchanged files, resulting in extremely large patch installation packages that are difficult to install or uninstall. Conventional technologies do not provide comparison tools beyond comparing a MD5 hash or string content in a file to determine if the file has changed. Conventional technologies do not provide comparison tools that encompass as many types of files as possible, and that can deeply analyze files into different types of files to filter out the truly changed files. Conventional technologies fail to provide flexible compare rules depending on the file type. Conventional technologies fail to provide a readable approach for analyzing and comparing binary file differences. Conventional technologies fail to parse binary data sections structure and then apply user configured schema rules to different file sections to filter out the changed files. Conventional technologies fail to take into consideration that file permissions may have changed. Conventional technologies fail to compare both the symbolic link and target files for symlink files.

By contrast, in at least some implementations in accordance with the current technique as described herein, a patch installation package generator system receives a plurality of files and a request to generate a patch installation package incorporating a subset of changed files for installation, where the plurality of files comprises the subset of changed files and a subset of unchanged files. A deep file compare system generates human readable files from binary files, where the plurality of files comprises the binary files. The deep file compare system determines the subset of changed files within the plurality of files, using the human readable files, and outputs the subset of changed files for generation of the patch installation package incorporating the subset of changed files.

Thus, a goal of the current technique is to provide a method and a system for a deep file comparison system. Another goal is to provide a way to identify changed files with compiled binary files, which are not directly readable. Another goal is to identify only the changed files, to generate a patch installation package that is as small as it can be to prevent difficulties when installing or uninstalling. Another goal is to provide comparison tools beyond comparing a MD5 hash or string content in a file to determine if the file has changed. Another goal is to provide comparison tools that encompass as many types of files as possible, and that can deeply analyze files into different types of files to filter out the truly changed files. Another goal is to provide flexible compare rules depending on the file type. Another goal is to provide a readable approach for analyzing and comparing binary file differences. Another goal is to parse binary data sections structure and then apply user configured schema rules to different file sections to filter out the changed files. Another goal is to take into consideration that file permissions may have changed.

Yet another goal is to compare both the symbolic link and target files for symlink files.

In at least some implementations in accordance with the current technique described herein, the use of a file deep compare system can provide one or more of the following advantages: provide a method and a system for a deep file comparison system, provide a way to identify changed files with compiled binary files, which are not directly readable, identify the changed files to generate a patch installation package that is as small as it can be to prevent difficulties when installing or uninstalling, provide comparison tools beyond comparing a MD5 hash or string content in a file to determine if the file has changed, provide comparison tools that encompass as many types of files as possible, and that can deeply analyze files into different types of files to filter out the truly changed files, provide flexible compare rules depending on the file type, provide a readable approach for analyzing and comparing binary file differences, parse binary data sections structure and then apply user configured schema rules to different file sections to filter out the changed files, take into consideration that file permissions may have changed, and compare both the symbolic link and target files for symlink files.

In contrast to conventional technologies, in at least some implementations in accordance with the current technique as described herein, a patch installation package generator system receives a plurality of files and a request to generate a patch installation package incorporating a subset of changed files for installation, where the plurality of files comprises the subset of changed files and a subset of unchanged files. A deep file compare system generates human readable files from binary files, where the plurality of files comprises the binary files. The deep file compare system determines the subset of changed files within the plurality of files, using the human readable files, and outputs the subset of changed files for generation of the patch installation package incorporating the subset of changed files.

In an example embodiment of the current technique, the deep file compare system strips binary files to assembly level data to generate the human readable files.

In an example embodiment of the current technique, the deep file compare system removes symbol tables and debugging information from the binary files.

In an example embodiment of the current technique, the deep file compare system parses binary data section structures of the binary files to create parsed binary files, and applies filter rules to the parsed binary files to identify changed binary files.

In an example embodiment of the current technique, the deep file compare system performs an assembly language level comparison to identify at least one unchanged file in the plurality of files.

In an example embodiment of the current technique, the deep file compare system classifies the plurality of files into a plurality of file types, where the plurality of file types comprises at least general file type, binary file type, compressed file type, and symlink file type.

In an example embodiment of the current technique, the deep file compare system classifies the plurality of files using python-magic with Multipurpose Internet Mail Extensions (MIME) protocol.

In an example embodiment of the current technique, a Schema State Machine (SSM) classifies the plurality of files into file types, where the SSM dynamically applies setup configurations to the classified files.

In an example embodiment of the current technique, a JavaScript Object Notation (JSON) setup file specifies the setup configurations to apply to each of the file types.

In an example embodiment of the current technique, the SSM transmits each of the classified files to a compare module, comprising a plurality of sub processes.

In an example embodiment of the current technique, the plurality of sub processes comprises a compression sub process, a general sub process, a binary sub process, a delete sub process, a permission sub process, a symlink sub process, and a new add sub process.

In an example embodiment of the current technique, a compression sub process receives at least one compressed file from the SSM, recursively decompresses at least one compressed file, and transmits the decompressed file to at least one of the plurality of sub processes.

In an example embodiment of the current technique, a symlink sub process receives at least one symbolic link file from the SSM, recursively retrieves at least one symbolic link associated with the symbolic link file, and transmits the symbolic link and at least one target file associated with the symbolic link file to a comparison module to identify changed symbolic link files.

In an example embodiment of the current technique, a binary sub process receives at least on Python™ compiled file from the SSM, and skips Python™ metadata associated with the Python™ compiled file when performing a comparison process on the Python™ compiled file.

In an example embodiment of the current technique, the deep file compare system post processes output from the compare module, and applies dependency schema rules to the output of the compare module.

In an example embodiment of the current technique, the deep file compare system, based on the output from the compare module, adds at least one required script file required by the patch installation package.

In an example embodiment of the current technique, a permission sub process receives a file, and performs a comparison process on at least one of file permissions associated with the file and folder permissions associated with a folder associated with the file.

In an example embodiment of the current technique, the deep file compare system provides the subset of changed files as input to a patch installation package generator system.

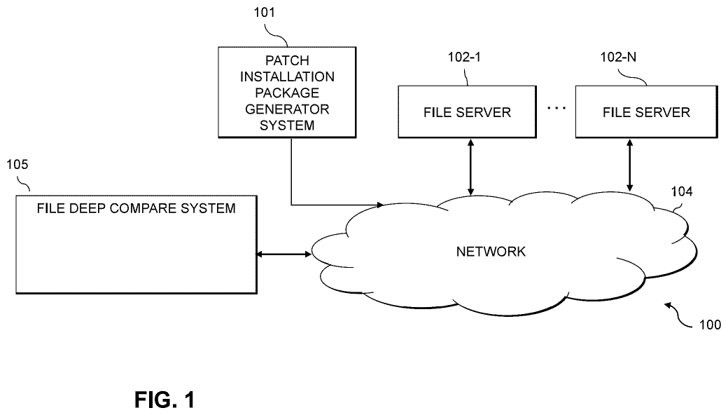

FIG. 1 shows a computer network (also referred to herein as an information processing system) 100 configured in accordance with an illustrative embodiment. The computer network 100 comprises a patch installation package generator system 101, file deep compare system 105, and file servers 102-N. The patch installation package generator system 101, file deep compare system 105, and file servers 102-N are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. The file deep compare system 105 may reside on a storage system. Such storage systems can comprise any of a variety of different types of storage including network-attached storage (NAS), storage area networks (SANs), direct-attached storage (DAS) and distributed DAS, as well as combinations of these and other storage types, including software-defined storage.

Each of the file servers 102-N may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.”

The file servers 102-N in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Also associated with the file deep compare system 105 are one or more input-output devices, which illustratively comprise keyboards, displays or other types of input-output devices in any combination. Such input-output devices can be used, for example, to support one or more user interfaces to the file deep compare system 105, as well as to support communication between the file deep compare system 105 and other related systems and devices not explicitly shown. For example, a dashboard may be provided for a user to view a progression of the execution of the file deep compare system 105. One or more input-output devices may also be associated with any of the file servers 102-N.

Additionally, the file deep compare system 105 in the FIG. 1 embodiment is assumed to be implemented using at least one processing device. Each such processing device generally comprises at least one processor and an associated memory, and implements one or more functional modules for controlling certain features of the file deep compare system 105.

More particularly, the file deep compare system 105 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the file deep compare system 105 to communicate over the network 104 with the patch installation package generator system 101, and file servers 102-N and illustratively comprises one or more conventional transceivers. In an example embodiment, the patch installation package generator system 101 may comprise the file deep compare system 105.

A file deep compare system 105 may be implemented at least in part in the form of software that is stored in memory and executed by a processor, and may reside in any processing device. The file deep compare system 105 may be a standalone plugin that may be included within a processing device.

It is to be understood that the particular set of elements shown in FIG. 1 for file deep compare system 105 involving the patch installation package generator system 101, and file servers 102-N of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the file deep compare system 105 can be on and/or part of the same processing platform.

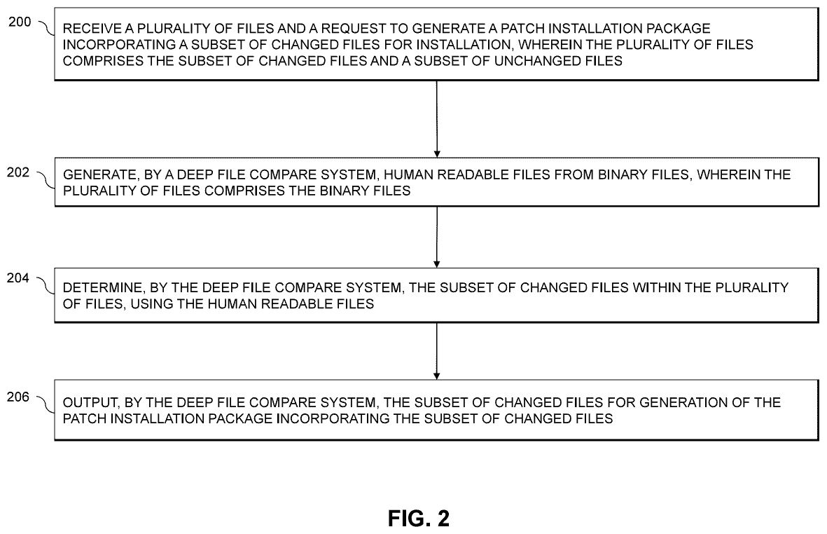

FIG. 2 is a flow diagram of a process for execution of the file deep compare system 105 in an illustrative embodiment. It is to be understood that this particular process is only an example, and additional or alternative processes can be carried out in other embodiments.

At 200, the patch installation package generator system 101 receives a plurality of files and a request to generate a patch installation package incorporating a subset of changed files for installation, where the plurality of files comprises the subset of changed files and a subset of unchanged files. The patching system provides customers with resolution to issues those customers are experiencing. Files containing fixes or resolutions to the issues (i.e., the subset of changed files) are packaged into a patch package, and the customers install the patch package, which replaces old files with the patch files (i.e., those files that resolve the issues). The patch installation package generator system 101 requires, as input, the files have been modified to resolve the issues the customers are facing, and those modified files are bundled into the patch installation package by the patch installation package generator system 101. The challenge is determining which files, from the plurality of files, have been changed/modified (i.e., the subset of changed files).

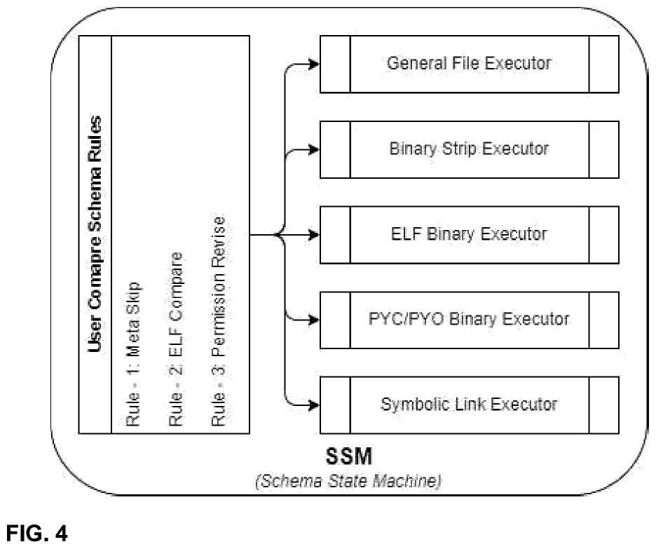

At 202, the file deep compare system 105 generates human readable files from binary files, where the plurality of files comprises the binary files. In an example embodiment, the binary files may comprise so, elf, co, obj, pyo, image, audio, video, etc. files, in other words, files whose content is not human readable. In particular, compiled files, such as so, co, obj, elf, etc. are not human readable. As shown in FIG. 4, a schema state machine comprises a plurality of executors. Two of the executors pertain to binary files. The elf binary executor handles elf, so, co, exe, etc. files, while the pyc/pyo binary executor handles pyc and pyo files. In an example embodiment, the commands “readelf” and “objdump” are used to analyze binary files. In an example embodiment, the executor can be thought of as a rules applying container, which each executor is applied to a specific file type, and where each executor may manage multiple schema rules for a particular file type. In an example embodiment, users may add additional executors, based on classified file types for smaller granularity. In an example embodiment, once the executors have processed the specific file types, the schema state machine sends those processed files to a sub process compare module.

In an example embodiment, the file deep compare system 105 strips binary files to assembly level data to generate the human readable files. For example, symbol tables and debugging information are used for debugging programs, and therefore, may be removed in a production environment to reduce file size and runtime memory usage. Performing the strip operation can significantly reduce the size of the binary file, reducing disk space usage and loading time. In an example embodiment, the “strip” option is configurable for the user/customer. In other words, the file deep compare system 105 performs an assembly language level comparison to identify at least one unchanged file in the plurality of files.

In an example embodiment, the file deep compare system 105 parses the binary data section structures of the binary files to create parsed binary files, and applies filter rules to the parsed binary files to identify changed binary files. In an example embodiment, any one or more of the data sections may be compared to determine if the binary file is a changed file. In an example embodiment, the file deep compare system 105 utilizes “readelf” and “objdump” to filter out specific data sections. The data is then treated as string content during the comparison phase. In an example embodiment, a section filter option is configurable by a user. In an example embodiment, the file deep compare system 105 applies smaller granularity filter rules to the parsed binary files. For example, an unchanged binary file may have different content, due to being compiled by different compilers, leading to subtle differences. For example, a “Library runpath” defined in a “dynstr” section will contain different data if compiled by different compilers (even though the content remains the same, but the sequence of, for example, “/usr/likewise/lib” will change). In an example embodiment, the file deep compare system 105 provides configuration options to, for example, ignore this type of granularity level sequence change. In an example embodiment, the file deep compare system 105 determines whether the binary files have changed by two dimensions, the content differences after the filer rules have been applied, and the granularity filter rules have been applied.

At 204, the file deep compare system 105 determines the subset of changed files within the plurality of files, using the human readable files. In an example embodiment, the file deep compare system 105 classifies the plurality of files into a plurality of file types, where the plurality of file types comprises at least general file type, binary file type, compressed file type, and symlink file type. In an example embodiment, the file deep compare system 105 classifies the plurality of files using python-magic with Multipurpose Internet Mail Extensions (MIME) protocol. Once the plurality of files is classified, the file deep compare system 105 can then perform the comparison processes to determine the subset of changed files.

In an example embodiment, a Schema State Machine (SSM), as illustrated in FIG. 4, classifies the plurality of files into file types, where the SSM dynamically applies setup configurations to the classified files. In an example embodiment, the schema state machine applies schema rules dynamically to the plurality of files, and then the files are transmitted to sub processes for further comparison. In an example embodiment, each of the plurality of files pass through the schema state machine. In one example embodiment, setup configurations are applied to the files. In another example embodiment, setup configurations are skipped. In another example embodiment, data sections are stripped from binary files. In another example embodiment, keywords in the file are ignored. In yet another example embodiment, metadata is stripped from the pyc/pyo files.

In an example embodiment, the schema state machine contains rule executors to perform each rule for different types of files. In an example embodiment, users may determine which types of files have which rules applied. In an example embodiment, users may determine which executors the files are transmitted to, and each file may be transmitted to multiple executors, each with different rules.

In an example embodiment, a JavaScript Object Notation (JSON) setup file specifies the setup configurations to apply to each of the file types. In an example embodiment, the JSON setup file may comprise user rule aliases, where each alias maps to a schema rule. In this example embodiment, a user fills in the alias to correspond to a specific file type, and the schema state machine applies the schema rule automatically for the specified file type. In an example embodiment, the JSON setup file is scalable, where a user may add additional rules and corresponding aliases according to their requirements.

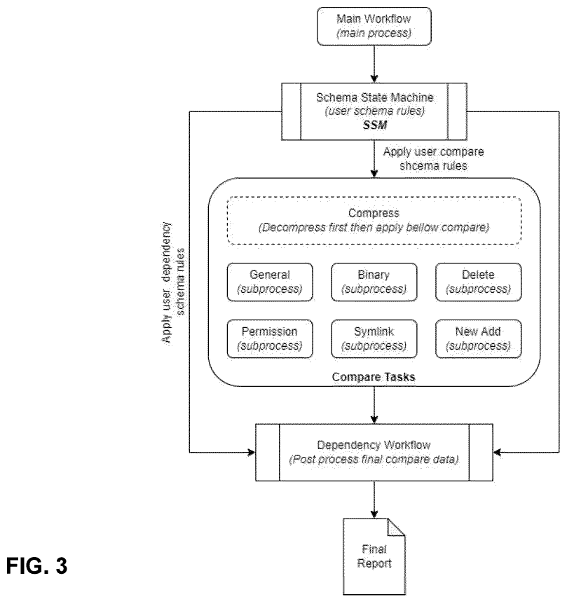

As noted above, once the executors have processed the specific file types, the schema state machine transmits each of the processed and classified files to a compare module, comprising a plurality of sub processes. In an example embodiment, as illustrated in FIG. 3, the plurality of sub processes comprises a compression sub process, a general sub process, a binary sub process, a delete sub process, a permission sub process, a symlink sub process, and a new add sub process. Each file from the plurality of files is processed by the schema state machine, and then transmitted to one of the seven sub processes accordingly. At the end of the compare module (labeled as “Compare Tasks” in FIG. 3), there is a dependency workflow to apply user schema rules. For example, user may add correlated script files that are required by the patch installation package.

In an example embodiment, a compression sub process receives at least one compressed file from the schema state machine. Compressed files cannot be compared directly since their MD5 values are changed once compressed, even if the content of the files is unchanged. The compression sub process recursively decompresses the compressed file or files (there may be compressed packages comprising sub-compressed packages), and transmits the decompressed file(s) to at least one of the plurality of sub processes. The compressed files may comprise several formats, such as zip, tar, bzip, etc. In an example embodiment, the schema state machine classifies compressed files into three types according to Multipurpose Internet Mail Extensions (MIME) standard as listed below:
application/x-gzip, application/x-bzip2, application/x-tar
application/zip
application/gzip, application/zlib, application/x-xz

In an example embodiment, the classification types are based on the decompress commands (and behaviors) used to decompress the compressed files. For example, application/x-gzip, application/x-bzip2, and application/x-tar are using the same command with different arguments. These commands keep the source zipped files after the unzip command is performed, while application/gzip, application/zlib, and application/x-xz delete the source zipped file after the unzip command is performed. As noted above, after the compressed file are decompressed, the schema state machine transmits the files to the respective sub process.

In an example embodiment, a general sub process receives a file. In an example embodiment, changed files are identified using line compare mode. The file string content is split into lines by, for example, Python™, and then compared line by line. In an example embodiment, regular expression (Regex) is used to match or ignore come content during the comparison process within the general sub process. In an example embodiment, file permission changes are determined by comparing mod bits values associated with the file.

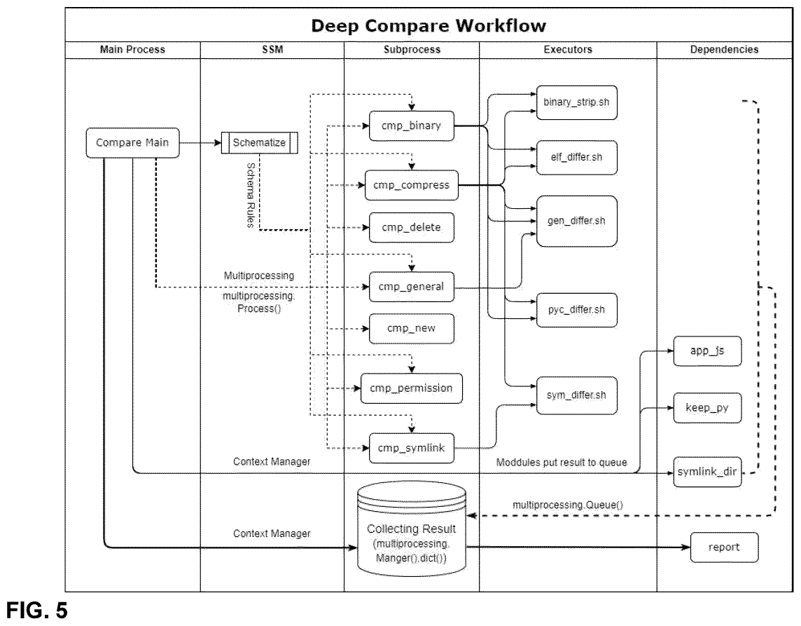

In an example embodiment, a symlink sub process receives at least one symbolic link file from the schema state machine. Often, with symbolic link files, the target files are not changed, but the symbolic link has changed and this may lead to the installation of the patch package failing. As illustrated in FIG. 4, the schema state machine comprises a symbolic link executor. In an example embodiment, the symlink sub process recursively retrieves at least one symbolic link associated with the symbolic link file (symbolic links can be linked to another symbolic link). For example, the “readlink” command may be used, and then the sumbolic link executor applies user rules. In an example embodiment, the symlink sub process transmits the symbolic link and target file associated with the symbolic link file to a comparison module to identify changed symbolic link files. In other words, the symlink sub process transmits the symbolic link and the target files to the symlink compare task (cmp_symlink) as illustrated in FIG. 5. The symlink compare task will compare both the symbolic link and target files to determine any content changes. In an example embodiment, an option, “symbolic diff” is configurable for users. In an example embodiment, the schema state machine also compares the mod bit permission changes associated with the symlink files.

In an example embodiment, a binary sub process receives, from the schema state machine, at least on Python™ compiled file. The binary sub process skips Python™ metadata associated with the Python™ compiled file when performing a comparison process on the Python™ compiled file. After compiling, pyc and pyo files may be marked as changed even though their content remains unchanged. This change may be because the Python™ metadata, “Magic Number” is changed. In particular, the “Modify Date” in the “Magic Number” is updated after each compile process. In an example embodiment, the schema state machine parses pyc and pyo files using Python™ lib “struct” and “marshal”. In an example embodiment, the schema state machine skips this portion of the metadata, and performs the comparison on the remaining portions of the Python™ compiled file.

Different Python™ versions have different lengths of metadata, and the content will also change. In an example embodiment, the schema state machine uses the shell command “cmp” with -i option to skip the metadata. For example, 8 bytes are skipped for Python™ 2.7, 12 bytes are skipped for Python™ 3.6, and 16 bytes are skipped for Python™ 3.8 and higher. In an example embodiment, data sections of the pyc and pyo files are compared using the Python™ lib “struct” and “marshal” parsed content. As illustrated in FIG. 4, the PYC/PYO Binary Executor applies a rule to skip the “Magic Number”. In an example embodiment, a user may also configure additional rules for the PYC/PYO Binary Executor.

In an example embodiment, a permission sub process receives a file, and performs a comparison process on at least one of file permissions associated with the file and folder permissions associated with a folder associated with the file.

In an example embodiment, as illustrated in FIG. 3, the schema state machine performs post processing, via the Dependency Workflow, on the output from the compare module (labeled as “Compare Tasks” in FIG. 3). The schema state machine then applies dependency schema rules to the output of the compare module. For example, based on the output from the compare module, the deep file compare system adds at least one required script file required by the patch installation package.

At 206, the file deep compare system 105 outputs the subset of changed files for generation of the patch installation package incorporating the subset of changed files. In an example embodiment, the file deep compare system 105 provides the subset of changed files as input to a patch installation package generator system. In an example embodiment, an.xml file is created from the output of the file deep compare system 105, and is used by the patch installation package generator system 101 to generate the patch installation package. The patch is then delivered to the customer for installation.

Accordingly, the particular processing operations and other functionality described in conjunction with the flow diagram of FIG. 2 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to provide a way to identify changed files within compiled binary files, which are not directly readable. Embodiments disclosed herein identify only the changed files and do not include unchanged files in patch installation packages, to create patch installation packages that are as small as they need to be. Embodiments disclosed herein provide comparison tools beyond comparing a MD5 hash or string content in a file to determine if the file has changed. Embodiments disclosed herein provide comparison tools that encompass as many types of files as possible, and that can deeply analyze files into different types of files to filter out the truly changed files. Embodiments disclosed herein provide flexible compare rules depending on the file type. Embodiments disclosed herein provide a readable approach for analyzing and comparing binary file differences. Embodiments disclosed herein parse binary data sections structure and then apply user configured schema rules to different file sections to filter out the changed files. Embodiments disclosed herein take into consideration that file permissions may have changed. Embodiments disclosed herein compare both the symbolic link and target files for symlink files.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the information processing system 100. For example, containers can be used to implement respective processing devices providing compute and/or storage services of a cloud-based system. Again, containers may be used in combination with other virtualization infrastructure such as virtual machines implemented using a hypervisor.

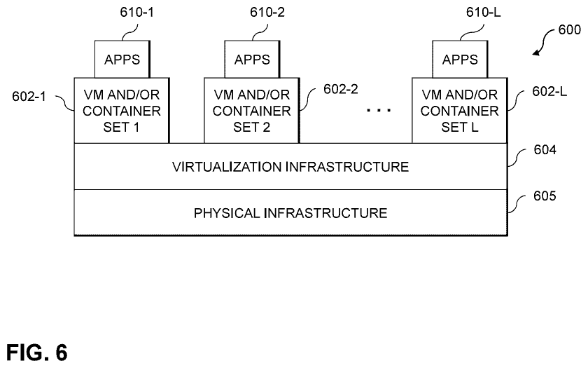

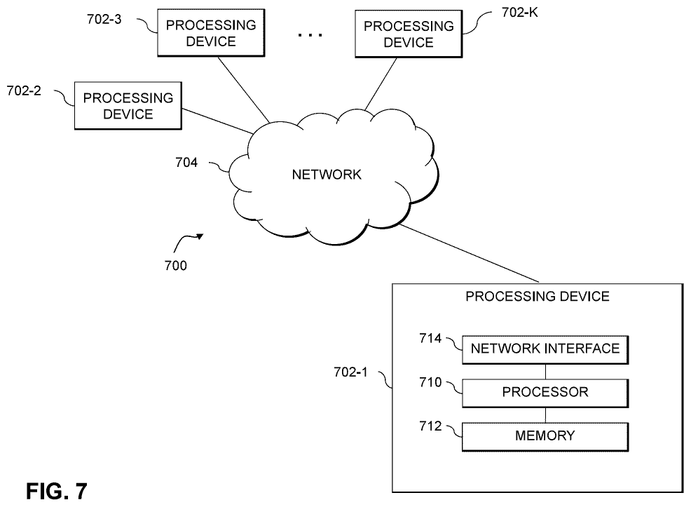

Illustrative embodiments of processing platforms will now be described in greater detail with reference to FIGS. 6 and 7. Although described in the context of the information processing system 100, these platforms may also be used to implement at least portions of other information processing systems in other embodiments.

FIG. 6 shows an example processing platform comprising cloud infrastructure 600. The cloud infrastructure 600 comprises a combination of physical and virtual processing resources that are utilized to implement at least a portion of the information processing system 100. The cloud infrastructure 600 comprises multiple virtual machines (VMs) and/or container sets 602-1, 602-2, . . . 602-L implemented using virtualization infrastructure 604. The virtualization infrastructure 604 runs on physical infrastructure 605, and illustratively comprises one or more hypervisors and/or operating system level virtualization infrastructure. The operating system level virtualization infrastructure illustratively comprises kernel control groups of a Linux operating system or other type of operating system.

The cloud infrastructure 600 further comprises sets of applications 610-1, 610-2, . . . 610-L running on respective ones of the VMs/container sets 602-1, 602-2, . . . 602-L under the control of the virtualization infrastructure 604. The VMs/container sets 602 comprise respective VMs, respective sets of one or more containers, or respective sets of one or more containers running in VMs. In some implementations of the FIG. 6 embodiment, the VMs/container sets 602 comprise respective VMs implemented using virtualization infrastructure 604 that comprises at least one hypervisor.

A hypervisor platform may be used to implement a hypervisor within the virtualization infrastructure 604, where the hypervisor platform has an associated virtual infrastructure management system. The underlying physical machines comprise one or more distributed processing platforms that include one or more storage systems.

In other implementations of the FIG. 6 embodiment, the VMs/container sets 602 comprise respective containers implemented using virtualization infrastructure 604 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of the information processing system 100 may each run on a computer, server, storage device or other processing platform element. A given such element is viewed as an example of what is more generally referred to herein as a “processing device.” The cloud infrastructure 600 shown in FIG. 6 may represent at least a portion of one processing platform. Another example of such a processing platform is processing platform 700 shown in FIG. 7.

The processing platform 700 in this embodiment comprises a portion of the information processing system 100 and includes a plurality of processing devices, denoted 702-1, 702-2, 702-3, . . . 702-K, which communicate with one another over a network 704.

The network 704 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 702-1 in the processing platform 700 comprises a processor 710 coupled to a memory 712.

The processor 710 comprises a microprocessor, a microcontroller, an application-specific integrated circuit (ASIC), a field-programmable gate array (FPGA) or other type of processing circuitry, as well as portions or combinations of such circuitry elements.

The memory 712 comprises random access memory (RAM), read-only memory (ROM) or other types of memory, in any combination. The memory 712 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 702-1 is network interface circuitry 714, which is used to interface the processing device with the network 704 and other system components, and may comprise conventional transceivers.

The other processing devices 702 of the processing platform 700 are assumed to be configured in a manner similar to that shown for processing device 702-1 in the figure.

Again, the particular processing platform 700 shown in the figure is presented by way of example only, and the information processing system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
receiving a plurality of files and a request to generate a patch installation package incorporating a subset of changed files for installation, wherein the plurality of files comprises the subset of changed files and a subset of unchanged files;
generating, by a deep file compare system, human readable files from binary files, wherein the plurality of files comprises the binary files;
determining, by the deep file compare system, the subset of changed files within the plurality of files, using the human readable files; and
outputting, by the deep file compare system, the subset of changed files for generation of the patch installation package incorporating the subset of changed files, wherein the method is performed by at least one processing device comprising a processor coupled to a memory.

2. The method of claim 1 wherein generating, by the deep file compare system, human readable files from binary files comprises:
stripping binary files to assembly level data to generate the human readable files.

3. The method of claim 2 wherein stripping the binary files to assembly level data comprises:
removing symbol tables and debugging information from the binary files.

4. The method of claim 2 further comprising:
parsing binary data section structures of the binary files to create parsed binary files; and
applying filter rules to the parsed binary files to identify changed binary files.

5. The method of claim 2 further comprising:
performing an assembly language level comparison to identify at least one unchanged file in the plurality of files.

6. The method of claim 1 wherein determining, by the deep file compare system, the subset of changed files comprises:
classifying the plurality of files into a plurality of file types, wherein the plurality of file types comprises at least general file type, binary file type, compressed file type, and symlink file type.

7. The method of claim 6 wherein classifying the plurality of files into a plurality of file types comprises:
classifying the plurality of files using python-magic with Multipurpose Internet Mail Extensions (MIME) protocol.

8. The method of claim 1 wherein determining, by the deep file compare system, the subset of changed files comprises:
classifying, by a Schema State Machine (SSM), the plurality of files into file types, wherein the SSM dynamically applies setup configurations to the classified files.

9. The method of claim 8 wherein a JavaScript Object Notation (JSON) setup file specifies the setup configurations to apply to each of the file types.

10. The method of claim 8 further comprising:
transmitting, by the SSM, each of the classified files to a compare module, comprising a plurality of sub processes.

11. The method of claim 10 wherein the plurality of sub processes comprises a compression sub process, a general sub process, a binary sub process, a delete sub process, a permission sub process, a symlink sub process, and a new add sub process.

12. The method of claim 10 further comprising:
receiving, by a compression sub process, at least one compressed file from the SSM;
recursively decompressing, by the compression sub process, the at least one compressed file; and
transmitting, by the compression sub process, the at least one decompressed file to at least one of the plurality of sub processes.

13. The method of claim 10 further comprising:
receiving, by a symlink sub process, at least one symbolic link file from the SSM;
recursively retrieving, by the symlink sub process, at least one symbolic link associated with the at least one symbolic link file; and
transmitting, by the symlink sub process, the at least one symbolic link and at least one target file associated with the at least one symbolic link file to a comparison module to identify changed symbolic link files.

14. The method of claim 10 further comprising:
receiving, by a binary sub process, at least on Python™ compiled file from the SSM;
skipping Python™ metadata associated with the at least one Python™ compiled file when performing a comparison process on the at least one Python™ compiled file.

15. The method of claim 10 further comprising:
post processing, by the deep file compare system, output from the compare module; and
applying dependency schema rules to the output of the compare module.

16. The method of claim 15 wherein applying dependency schema rules to the output of the compare module comprises:
based on the output from the compare module, adding, by the deep file compare system, at least one required script file required by the patch installation package.

17. The method of claim 10 further comprising:
receiving, by a permission sub process, a file; and
performing a comparison process on at least one of file permissions associated with the file and folder permissions associated with a folder associated with the file.

18. The method of claim 1 wherein outputting, by the deep file compare system, the subset of changed files comprises:
providing, by the deep file compare system, the subset of changed files as input to a patch installation package generator system.

19. A system comprising:
at least one processing device comprising a processor coupled to a memory;
the at least one processing device being configured:
to receive a plurality of files and a request to generate a patch installation package incorporating a subset of changed files for installation, wherein the plurality of files comprises the subset of changed files and a subset of unchanged files;
to generate, by a deep file compare system, human readable files from binary files, wherein the plurality of files comprises the binary files;
to determine, by the deep file compare system, the subset of changed files within the plurality of files, using the human readable files; and
to output, by the deep file compare system, the subset of changed files for generation of the patch installation package incorporating the subset of changed files.

20. A computer program product comprising a non-transitory processor-readable storage medium having stored therein program code of one or more software programs, wherein the program code when executed by at least one processing device causes said at least one processing device:
to receive a plurality of files and a request to generate a patch installation package incorporating a subset of changed files for installation, wherein the plurality of files comprises the subset of changed files and a subset of unchanged files;
to generate, by a deep file compare system, human readable files from binary files, wherein the plurality of files comprises the binary files;
to determine, by the deep file compare system, the subset of changed files within the plurality of files, using the human readable files; and
to output, by the deep file compare system, the subset of changed files for generation of the patch installation package incorporating the subset of changed files.
